(19) United States
(12) Patent Application Publication
(10) Pub. No.: US 2011/0102507 A1
(43) Pub. Date: May 5, 2011

(54) LIQUID EJECTING APPARATUS

(75) Inventors: Yoichi YAMADA, Shiojiri-shi (JP); Kiyoteru KATSUKI, Azumino-shi (JP); Masaru KOBASHI, Matsumoto-shi (JP); Daisuke MATSUMOTO, Matsumoto-shi (JP); Yasunori KOIKE, Matsumoto-shi (JP); Narihiro OKI, Matsumoto-shi (JP); Takao SHIZUMA, Anjo-shi (JP)

(73) Assignee: SEIKO EPSON CORPORATION, Tokyo (JP)

(21) Appl. No.: 12/914,717

(22) Filed: Oct. 28, 2010

(30) Foreign Application Priority Data
Oct. 29, 2009 (JP) 2009-249171
Apr. 28, 2010 (JP) 2010-103854
Apr. 28, 2010 (JP) 2010-103902

(51) Int. Cl. B41J 23/00

(52) U.S. Cl. 347/37

(57) ABSTRACT

A region of the predetermined portion of the medium-to-be-ejected supporting unit in the second direction has a position corresponding to at least one lateral end of the medium to be ejected in the second direction, and extends towards the inside and outside of the medium to be ejected from the position. The at least one lateral end of the medium to be ejected in the second direction is configured such that a line connecting a terminal end position of the predetermined portion of the medium-to-be-ejected supporting unit which is further inside than an end portion of the medium to be ejected, and a terminal end position of the predetermined portion of the liquid ejecting unit which is further outside than the end portion of the medium to be ejected, intersects with the medium to be ejected.

### BACKGROUND

1. Technical Field

The present invention relates to a liquid ejecting apparatus which is represented by a fax machine or a printer.

2. Related Art

An ink jet printer will now be described as an example of a liquid ejecting apparatus. The ink jet printer includes an ink jet recording head and a support member (referred to as a platen) that is disposed at a position opposite to the ink jet recording head, and is adapted to define a distance between the ink jet recording head and a recording paper by supporting the recording paper with the support member.

Here, in ink jet printers in recent years there has been a tendency for the size of an ink droplet to become smaller in order to further improve the recording quality, and thus, the size of ink droplet has become smaller to, for example, several pl. For this reason, the mass of the ink droplet is extremely small, and even though the ink droplets are ejected onto the recording paper from the ink jet recording head, a part of the ink droplets is not landed on the recording paper, and floats in the form of mist, which leads to various problems in ink jet printers. In addition, in a so-called margin-less printing process in which the recording process is performed without any margin on four sides of the recording paper, since the ink droplets are ejected even onto a region offset from an end portion of the recording paper, the above-described mist floating phenomenon occurs more prominently.

Accordingly, as disclosed in JP-A-2007-118321 and JP-A-2007-118318, there has been proposed a technique of attracting the ink droplets toward the recording paper by setting to have a difference in potential between the ink jet recording head, the recording paper and the support member to generate an electric field and thus cause a coulomb force to act on the ink droplets.

### 1. Problems Caused by High-Speed Transport of Recording Paper

However, the recent years, ink jet printers are increasing in speed, particularly in regards to business application and the like, and thus the transportation velocity of the paper is remarkably increased as compared with the related art. In addition, in a so-called serial-type ink jet printer in which performs the recording while the inkjet recording head is moved in a direction perpendicular to a paper transportation direction to, since head scanning (recording) is executed while the paper is stopped, it is necessary to further increase the paper transportation velocity in order to prevent deterioration of the throughput.

However, it has been found that the following problems are caused due to the high-speed transportation of the recording paper as described above. That is, there is a case where paper powder generated when cutting a large original paper is adhered to the end portion (edge) of the recording paper or the surrounding region. If a potential between three elements (hereinafter referred to as “constituent element of the recording unit”), of the recording paper, the support member (platen), and the ink jet recording head, is not controlled, the paper powder adhered to the recording paper scatters and flies toward the ink jet recording head due to electric field generated between the constituent elements of the recording unit, so that the paper powder is adhered to the inkjet recording head. In particular, in a case where the recording paper is transported at high speed, vibration or impact generated at the time of transporting the paper is increased, and thus the scattering and flying of the paper powder occurs more prominently.

In addition, according to friction between the recording papers stored in a paper cassette or slidable contacting between the constituent elements (for example, an edge guide, a transportation roller or the like) of the paper transporting path and the recording paper, frictional electrification or peeling electrification becomes prominent, that is, the constituent elements of the recording unit are more prominently electrically charged. As a result, since the electric field formed between the constituent elements of the recording unit becomes stronger and the charging of the paper powder itself becomes stronger, the coulomb force applied to the paper powder is increased, so that the adhering of the paper powder to the ink jet recording head becomes more prominent.

Furthermore, even in a case where the paper powder itself is not charged, if the flying paper powder comes to be within the electric field, biased charges occur in the paper powder due to dielectric polarization or electrostatic induction, and thus the paper powder is attracted toward the inkjet recording head.

FIG. 11 is an explanatory view to illustrate the above problems, in which reference numeral 160 designates an ink jet recording head, reference numeral 160a designates a nozzle plate, reference numeral 170 designates a support member (platen), and reference numeral 170a designates a rib formed on the support member 170. In addition, P indicates recording paper, Pe indicates a paper end region, d indicates paper powder, and the circled “+” and “−” indicates charge polarities.

The recording paper P is neutralized by a neutralization brush or the like, and thus the paper powder d adhered to the recording paper P is not charged. However, as shown in an enlarged view of the paper powder d, in a case (one example) where the nozzle plate 160a is charged to be positive and the support member 170 is charged to be negative, negative charges appear the paper powder d on the side of the nozzle plate and positive charges appear the paper powder d on the side of the support member by the dielectric polarization (in a case where the paper powder d has a property of a dielectric body) or the electrostatic induction (in a case where the paper powder d has a property of conductor). Consequently, the paper powder d is attracted toward either of the nozzle plate 160a or the support member 170.

If the paper powder is adhered to the ink jet recording head, the paper powder directly blocks the nozzle opening or the paper powder moves to the nozzle opening at the time of cleaning (wiping) a nozzle surface, so that the dot omission occurs.

Further, in addition to the problem that the paper powder physically blocks the nozzle opening, a loading material, such as calcium carbonate, constituting the paper powder reacts with the moisture of the ink to thereby be thickened and to thereby deteriorate vibration of meniscus of the nozzle opening, which may disturb the ejection of the ink droplets. Accordingly, preventing the paper powder from being adhered to the ink jet recording head is very important so as to obtain the appropriate quality of the recording in the ink jet printer.

### 2. Problems of the Related Art

As described above, JP-A-2007-118321 and JP-A-2007-118318 propose the technique of attracting the ink droplets toward the recording paper by setting to have a difference in potential between the ink jet recording head, the recording paper and the support member (the constituent elements of the recording unit) to generate the electric field and thus cause the coulomb force to act on the ink droplets. Accordingly, assuming that the paper powder and the ink droplet are on the same line, it seems that it is possible to prevent the paper powder from being adhered to the ink jet recording head by controlling the electric field and attracting the paper powder toward the recording paper side.

However, cellulose fiber and loading material, which constitute the paper powder, are likely to be charged to any one of positive polarity and negative polarity in the triboelectric series. Accordingly, even though the flying of the paper powder to the ink jet recording head side is prevented by forming the electric field between the constituent elements of the recording units in a specific direction, it is not possible to prevent the paper powder charged to the opposite polarity from flying to the ink jet recording head side.

Further, a recording apparatus is disclosed in JP-A-2003-165230, in which, in order to prevent the paper powder, dust or the like from being adhered to the vicinity of the nozzle portion of the ink jet recording head, an air duct is provided to the vicinity of the nozzle plate, so that humidified air is sprayed from the air duct at the time of recording and at the time of recording standby. However, in such a configuration, the complicated configuration leads to increase in the size and cost of the recording apparatus, and the paper powder may become adhered to the recording head due to the air stream.

In addition, the technology of collecting the paper powder using a paper powder collecting member having a chargeable property is disclosed in JP-A-2008-213255. However, in this technology, the paper powder is not reliably effectively collected due to the above-described problem of the opposite polarity, and treatment (removal) of the paper powder accumulated on the paper powder collecting member becomes a problem. In particular, in a state where a lot of paper powder is accumulated, since the paper powder can be scattered in the vicinity thereof by slight vibration or impact, thereby causing a problem that performance cannot be maintained over the long term.

### SUMMARY

### 3. Problems that the Invention is to Solve

An advantage of some aspects of the invention is that it provides a liquid ejecting apparatus capable of reliably preventing foreign matter (hereinafter referred to as “paper powder or the like”) such as paper powder, dust or the like from being adhered to an inkjet recording head, without deteriorating its recording quality.

According to the first aspect of the invention, there is provided a liquid ejecting apparatus including: a liquid ejecting unit which is fixed in a second direction perpendicular to a first direction which is a transportation direction of a medium to be ejected, and ejects a liquid onto the medium to be ejected; a medium-to-be-ejected supporting unit which is provided opposite to the liquid ejecting unit and supports the medium to be ejected; and a same-potential setting unit which sets the same potential to a predetermined portion of the liquid ejecting unit side and a predetermined portion of the medium-to-be-ejected supporting unit side; in which a region of the predetermined portion of the medium-to-be-ejected supporting unit side in the second direction has a position corresponding to at least one lateral end of the medium to be ejected in the second direction, and extends towards inside and outside of the medium to be ejected from the position; and at least the one lateral end of the medium to be ejected in the second direction is configured so that a line connecting a terminal end position of the predetermined portion of the medium-to-be-ejected supporting unit side which is further inside than an end portion of the medium to be ejected, and a terminal end position of the predetermined portion of the liquid ejecting unit which is further outside than the end portion of the medium to be ejected, intersects with the medium to be ejected.

According to the aspect, the same potential is set to the predetermined portion of the medium-to-be-ejected supporting unit side and the predetermined portion of the liquid ejecting unit side by the same-potential setting unit. The predetermined portion of the medium-to-be-ejected supporting unit side has the position corresponding to the end of the medium to be ejected, and is a region extending towards the inside and outside of the medium to be ejected, so that the end region of the medium to be ejected is interposed between the predetermined portion of the medium-to-be-ejected supporting unit and the predetermined portion of the liquid ejecting unit which is set the same potential.

In addition, since the line connecting the terminal end position of the predetermined portion of the medium-to-be-ejected supporting unit side which is further inside than the end portion of the medium to be ejected, and the terminal end position of the predetermined portion of the liquid ejecting unit which is further outside than the position corresponding to the end portion of the medium to be ejected, is configured to intersect with the end portion of the medium to be ejected, even though the electric field is formed between the region positioned at the position further inside than the predetermined portion of the medium-to-be-ejected supporting unit side, and the liquid ejecting unit, the end portion of the medium to be ejected does not enter the inside of the electric field (described in detail hereinafter).

With the above description, the end region of the medium to be ejected, to which the paper powder or the like is most prominently adhered, reliably enters in the state where the electric field formed between the medium-to-be-ejected supporting unit and the liquid ejecting unit which are set to be at the same potential is very weak or the electric field is almost not formed (such a state is hereinafter referred to as a field-free state for the sake of convenience). Therefore, the paper powder or the like adhered to the end portion of the medium to be ejected is suppressed from scattering or flying, and most of the paper powder or the like is discharged with the medium to be ejected outwardly from the apparatus, as it is adhered to the end portion of the medium to be ejected. Accordingly, it is possible to reliably prevent the adhering of the paper powder or the like to the liquid ejecting unit.

According to the second aspect of the invention, there is provided a liquid ejecting apparatus including: a liquid ejecting unit which ejects a liquid onto the medium to be ejected while moving is moved in a second direction perpendicular to a first direction which is a transportation direction of a medium to be ejected; a medium-to-be-ejected supporting unit which is provided opposite to the liquid ejecting unit and supports the medium to be ejected; and a same-potential setting unit which sets to the same potential at a predetermined portion of the liquid ejecting unit side and a predetermined portion of the medium-to-be-ejected supporting unit side; in which a region of the predetermined portion of the medium-to-be-ejected supporting unit side in the second direction has a position corresponding to at least one lateral end of the medium to be ejected in the second direction, and extends towards inside and outside of the medium to be ejected from the position; and when the medium to be ejected is transported in a state in which the liquid ejecting unit is stationary in the vicinity of the one lateral end region of the medium to be ejected in the second direction, at least the one lateral end of the medium to be ejected in the second direction is configured so that a line connecting a terminal end position of the predetermined portion of the medium-to-be-ejected supporting unit side which is further inside than an end portion of the medium to be ejected, and a terminal end position of the predetermined portion of the liquid ejecting unit which is further outside than the end portion of the medium to be ejected, intersects with the medium to be ejected.

According to the aspect, the same potential is set to the predetermined portion of the medium-to-be-ejected supporting unit side and the predetermined portion of the liquid ejecting unit side by the same-potential setting unit. The predetermined portion of the medium-to-be-ejected supporting unit side has the position corresponding to the end of the medium to be ejected, and is a region extending towards the inside and outside of the medium to be ejected. Therefore, if the liquid ejecting means is stopped in the vicinity of the end region of the medium to be ejected, the end region of the medium to be ejected is interposed between the predetermined portion of the medium-to-be-ejected supporting unit and at the predetermined portion of the liquid ejecting unit which are set to the same potential.

In addition, since it is configured such that the line connecting the terminal end position of the predetermined portion of the medium-to-be-ejected supporting unit side which is further inside than the end portion of the medium to be ejected, and the terminal end position of the predetermined portion of the liquid ejecting unit which is further outside than the end portion of the medium to be ejected, intersects with the end portion of the medium to be ejected, even though the electric field is formed between the region positioned at the position inner than the predetermined portion of the medium-to-be-ejected supporting unit side, and the liquid ejecting unit, the end portion of the medium to be ejected does not enter the inside of the electric field (will be described in detail hereinafter).

With the above description, the end region of the medium to be ejected, to which the paper powder or the like is most prominently adhered, reliably enters in the state where the electric field formed between the medium-to-be-ejected supporting unit and the liquid ejecting unit which are set to be at the same potential is very weak or the electric field is almost not formed, that is, in the field-free state. Therefore, the paper powder or the like adhered to the end portion of the medium to be ejected can be reliably suppressed from scattering or flying, and most of the paper powder or the like is discharged with the medium to be ejected outwardly from the apparatus, as it is adhered to the end portion of the medium to be ejected. Accordingly, it is possible to reliably prevent the adhering of the paper powder or the like to the liquid ejecting unit.

In the first or second aspect, the third aspect of the invention is that a line connecting a terminal end position of the predetermined portion of the medium-to-be-ejected supporting unit side which is further outside than the end portion of the medium to be ejected, and a terminal end position of the predetermined portion of liquid ejecting unit which is farther away than the outer terminal end position in the predetermined portion of the medium-to-be-ejected supporting unit side does not intersect with the medium to be ejected.

According to the aspect, since the line connecting the terminal end position of the predetermined portion of the medium-to-be-ejected supporting unit side which is further outside than the end portion of the medium to be ejected, and the terminal end position of the predetermined portion of liquid ejecting unit which is farther away than the outer terminal end position in the predetermined portion of the medium-to-be-ejected supporting unit side is configured so as not to intersect with the medium to be ejected, even though the electric field is formed between the region positioned at the position farther away than the predetermined portion of the medium-to-be-ejected supporting unit side, and the liquid ejecting unit, the end portion of the medium to be ejected does not enter the inside of the electric field (described in detail hereinafter). Accordingly, the end region of the medium to be ejected, to which the paper powder or the like is most prominently adhered, enters more reliably in the field-free state, thereby preventing the paper powder or the like from flying and being adhered to the liquid ejecting unit.

In the first to third aspects, the fourth aspect of the invention is that the same-potential setting unit sets the same potential to the medium to be ejected, in addition to the predetermined portion of the liquid ejecting unit side and the predetermined portion of the medium-to-be-ejected supporting unit side.

According to the aspect, in addition, the predetermined portion of the liquid ejecting unit side and the medium to be ejected are also set to the same potential with respect to the end region of the medium to be ejected, and thus between the liquid ejecting unit and the medium to be ejected is set to the field-free state. Accordingly, since the end portion of the medium to be ejected is laid in the complete field-free region, the paper powder or the like adhered to the end portion of the medium to be ejected is more reliably suppressed from scattering or flying, and most of the paper powder or the like is discharged with the medium to be ejected outwardly from the apparatus, as it is adhered to the end portion of the medium to be ejected. Therefore, it is possible to more reliably prevent the paper powder or the like from being adhered to the liquid ejecting unit.

In the fourth aspect, the fifth aspect of the invention is that the same-potential setting unit sets the same potential to the predetermined portion of the liquid ejecting unit side, the predetermined portion of the medium-to-be-ejected supporting unit side and the medium to be ejected by ground connection.

According to the aspect, since the same-potential setting unit sets the same potential to the predetermined portion of the liquid ejecting unit side, the predetermined portion of the medium-to-be-ejected supporting unit side and the medium to be ejected by ground connection, a potential setting unit is not necessary, thereby obtaining a reduction in the cost of the apparatus.

In any one of the first to fifth aspects, the sixth aspect of the invention is that the predetermined portion of the liquid ejecting unit side is a surface opposite to the medium-to-be-ejected supporting unit, and the predetermined portion of the medium-to-be-ejected supporting unit side is a surface opposite to the liquid ejecting unit.

According to the aspect, since the predetermined portions of the liquid ejecting unit side and the medium-to-be-ejected supporting unit side which are set to the same potential (a portion of which the potential is controlled) are surfaces opposite to each other, it is possible to suppress the inflow electric field from the surroundings, and thus the paper powder or the like can more reliably enter in the field-free state.

According to the seventh aspect of the invention, there is provided a liquid ejecting apparatus including: a liquid ejecting unit which ejects a liquid onto a medium to be ejected; a medium-to-be-ejected supporting unit which is provided opposite to the liquid ejecting unit and supports the medium to be ejected, a same-potential setting unit which sets to the same potential at a predetermined portion of the liquid ejecting unit side and a predetermined portion of the medium-to-be-ejected supporting unit side in an end region of the medium to be ejected in a second direction perpendicular to a first direction which is a transportation direction of a medium to be ejected; and a region in the second direction except for the end region is configured so that a difference in potential is set between the predetermined portion of the liquid ejecting unit side and the predetermined portion of the medium-to-be-ejected supporting unit side.

According to the aspect, in addition, since the predetermined portion of the liquid ejecting unit side and the predetermined portion of the medium-to-be-ejected supporting unit side are set to the same potential with respect to the end region of the medium to be ejected, the electric field formed between the medium-to-be-ejected supporting unit and the liquid ejecting unit is very weak or the electric field is almost not formed (such a state is hereinafter referred to as a field-free state for the sake of convenience). That is, since the end portion of the medium to be ejected, to which the paper powder or the like is most prominently adhered, is laid in the field-free state which is formed between the liquid ejecting unit and the medium-to-be-ejected supporting unit, the paper powder or the like adhered to the end portion of the medium to be ejected is more reliably suppressed from scattering or flying, and most of the paper powder or the like is discharged with the medium to be ejected outwardly from the apparatus, as it is adhered to the end portion of the medium to be ejected. Therefore, it is possible to more reliably prevent the paper powder or the like from flying and being adhered to the liquid ejecting unit.

Meanwhile, the region except for the end region of the medium to be ejected is configured such that the difference in potential is formed between the predetermined portion of the liquid ejecting unit and the medium-to-be-ejected display unit in the region, the electric field is positively generated between the liquid ejecting unit side and the medium-to-be-ejected supporting unit, so that the liquid ejected from the liquid ejecting unit is attracted to the medium to be ejected by the coulomb force and thus is reliably landed thereon. Accordingly, it is possible to prevent deterioration of the liquid ejecting quality, and to solve the problem caused by the fact that the liquid floats in the form of mist.

In the first aspect, the eight aspect of the invention is that the same-potential setting unit sets the same potential to the predetermined portion of the liquid ejecting unit side and the medium to be ejected.

According to the aspect, in addition, the predetermined portion of the liquid ejecting unit side and the medium to be ejected are also set to the same potential with respect to the end region of the medium to be ejected, and thus the field-free state is caused between the liquid ejecting unit and the medium to be ejected. Accordingly, since the end portion of the medium to be ejected is laid in the complete field-free region, the paper powder or the like adhered to the end portion of the medium to be ejected is more reliably suppressed from scattering or flying, and most of the paper powder or the like is discharged with the medium to be ejected outwardly from the apparatus, as it is adhered to the end portion of the medium to be ejected. Therefore, it is possible to more reliably prevent the paper powder or the like from being adhered to the liquid ejecting unit.

In the first or second aspect, the ninth aspect of the invention is that a plurality of regions, in which the same potential is set to the predetermined portion of the liquid ejecting unit side and the predetermined portion of the medium-to-be-ejected supporting unit side, are provided depending upon a size of the medium to be ejected having plural sizes in the second direction.

According to the aspect, since a plurality of the regions, in which the same potential is set to the predetermined portion of the liquid ejecting unit side and the predetermined portion of the medium-to-be-ejected supporting unit side, are provided depending upon the size of the medium to be ejected having plural sizes in the second direction, it is possible to cope with the medium to be ejected having various sizes.

In the second or third aspect, the tenth aspect of the invention is that the same-potential setting unit sets the same potential to the predetermined portion of the liquid ejecting unit side, the predetermined portion of the medium-to-be-ejected supporting unit side and the medium to be ejected by ground connection.

According to the aspect, since the same-potential setting unit sets the same potential to the predetermined portion of the liquid ejecting unit side, the predetermined portion of the medium-to-be-ejected supporting unit side and the medium to be ejected by ground connection, a potential setting unit is not necessary, thereby obtaining a reduction in the cost of the apparatus.

In any one of the second to fourth aspects, the eleventh aspect of the invention is that the same-potential setting unit has a contact portion which comes into electrically contact with the end region of the medium to be ejected, and the contact portion is provided at an upstream side of the liquid ejecting unit in a transporting path along which the medium to be ejected is transported, and is constituted of a roller which transports the medium to be ejected.

According to the aspect, since the contact portion of the same-potential setting unit which comes into contact with the medium to be ejected is constituted of the roller which transports the medium to be ejected, it is possible to simply and inexpensively constitute the same-potential setting unit using existing constituent elements.

In any one of the first to fifth aspects, the twelfth aspect of the invention is that the predetermined portion of the liquid ejecting unit side is a surface opposite to the medium-to-be-ejected supporting unit, and the predetermined portion of the medium-to-be-ejected supporting unit side is a surface opposite to the liquid ejecting unit.

According to the aspect, since the predetermined portions of the liquid ejecting unit side and the medium-to-be-ejected supporting unit side which are set to the same potential (a portion of which the potential is controlled) are the surfaces opposite to each other, it is possible to suppress the inflow electric field from the surroundings, and thus the paper powder or the like can be more reliably laid in the field-free state.

In any one of the first to sixth aspects, the thirteenth aspect of the invention is that a region of the predetermined portion of the medium-to-be-ejected supporting unit side in the second direction has a position corresponding to at least one lateral end of the medium to be ejected in the second direction, and extends towards the inside and outside of the medium to be ejected from the position, and at least the one lateral end of the medium to be ejected in the second direction is configured so that a line connecting a terminal end position of the predetermined portion of the medium-to-be-ejected supporting unit which is further inside than an end portion of the medium to be ejected, and a terminal end position of the predetermined portion of the liquid ejecting unit which is further outside than the end portion of the medium to be ejected, intersects with the medium to be ejected.

According to the aspect, since the line connecting the terminal end position of the predetermined portion of the medium-to-be-ejected supporting unit side which is further inside than the end portion of the medium to be ejected, and the terminal end position of the predetermined portion of liquid ejecting unit which is further outside than the position corresponding to the end portion of the medium to be ejected is configured so as to intersect with the medium to be ejected, even though the electric field is formed between the region positioned at the position inner than the predetermined portion of the medium-to-be-ejected supporting unit side, and the liquid ejecting unit, the end portion of the medium to be ejected does not enter the inside of the electric field (will be described in detail hereinafter).

### BRIEF DESCRIPTION OF THE DRAWINGS

The invention will be described with reference to the accompanying drawings, wherein like numbers reference like elements.

FIG. 1 is a cross-sectional view schematically illustrating a printer paper transporting path according to the invention;

FIG. 2 is a conceptual diagram illustrating principal idea of the invention;

FIG. 3 is a view illustrating a charging state in a recording region of a printer according to the invention (first embodiment);

FIG. 4 is a view illustrating a charging state in a recording region of a printer according to the invention (second embodiment);

FIG. 5 is a view illustrating a charging state in a recording region of a printer according to the invention (third embodiment);

FIG. 6 is a view illustrating a charging state in a recording region of a printer according to the invention (fourth embodiment);

FIG. 7 is a view illustrating a charging state in a recording region of a printer according to the invention (fifth embodiment);

FIG. 8 is a view illustrating a charging state in a recording region of a printer according to the invention (sixth embodiment);

FIG. 9 is a view illustrating a member for grounding a paper end region;

FIG. 10 is a view illustrating another member for grounding a paper end region; and

FIG. 11 is a view illustrating a problem of the related art.

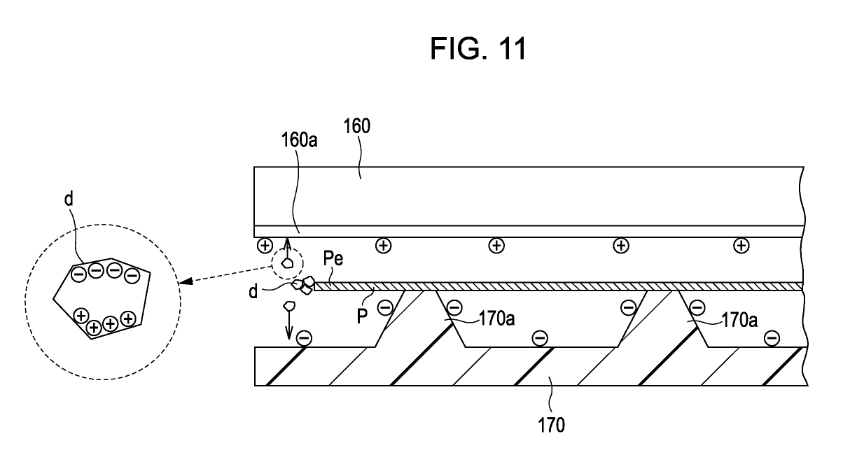

### DESCRIPTION OF EXEMPLARY EMBODIMENTS

An embodiment of the invention will now be described with reference to the accompanying drawings.

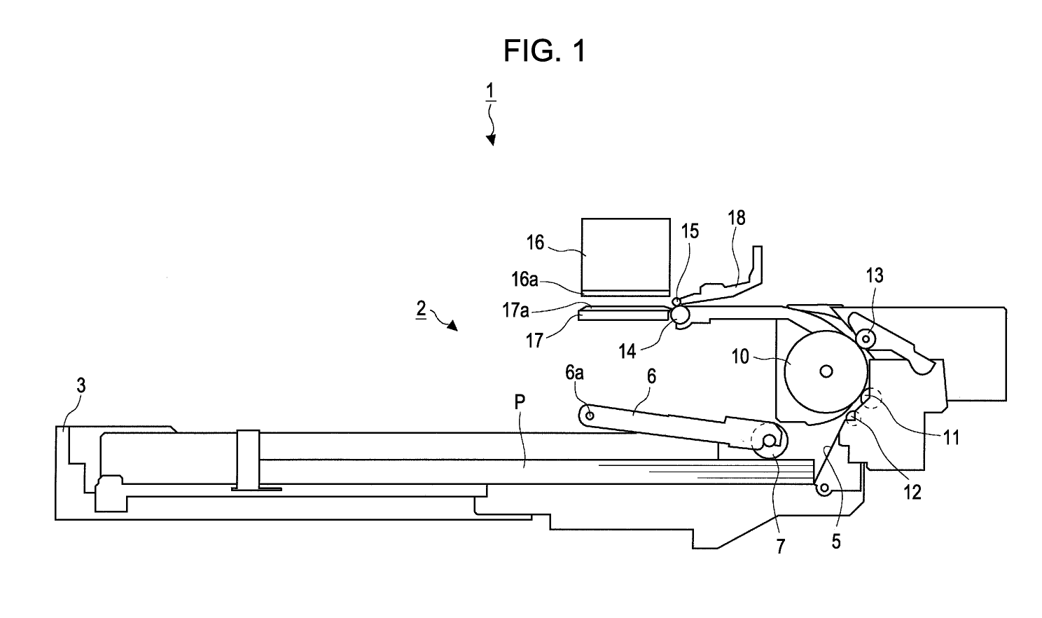

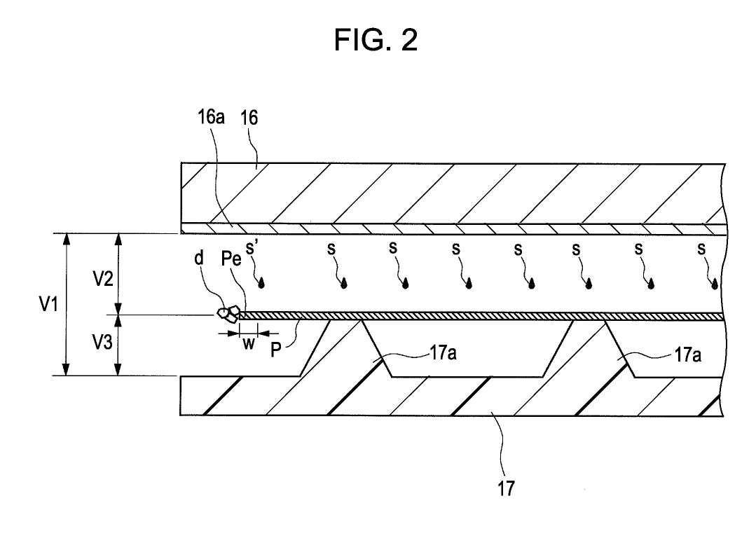

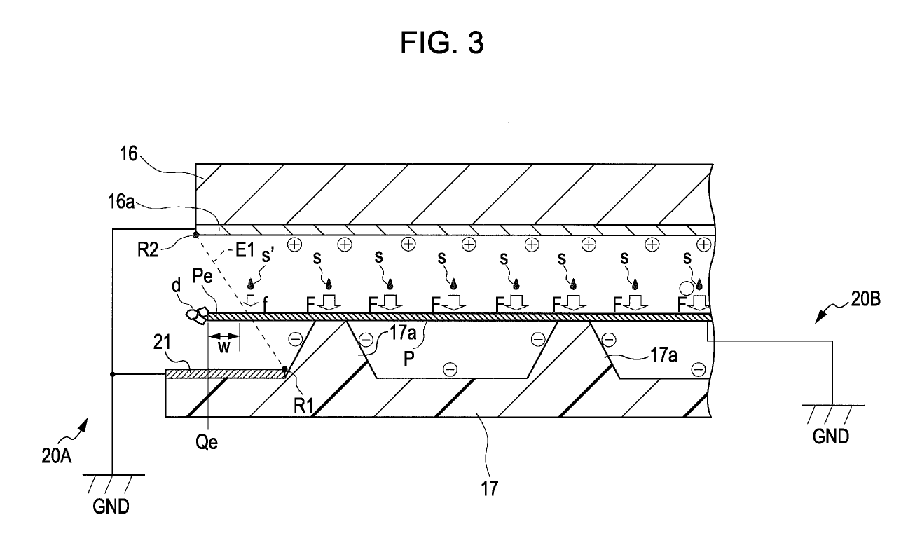

FIG. 1 is a cross-sectional view schematically illustrating a printer paper transporting path of an ink jet printer 1 according to the invention. FIG. 2 is a conceptual diagram illustrating the principal idea of the invention. FIGS. 3 to 8 are views illustrating a charging state in a recording region of the ink jet printer according to the invention to respectively show different embodiments (first to sixth embodiments).

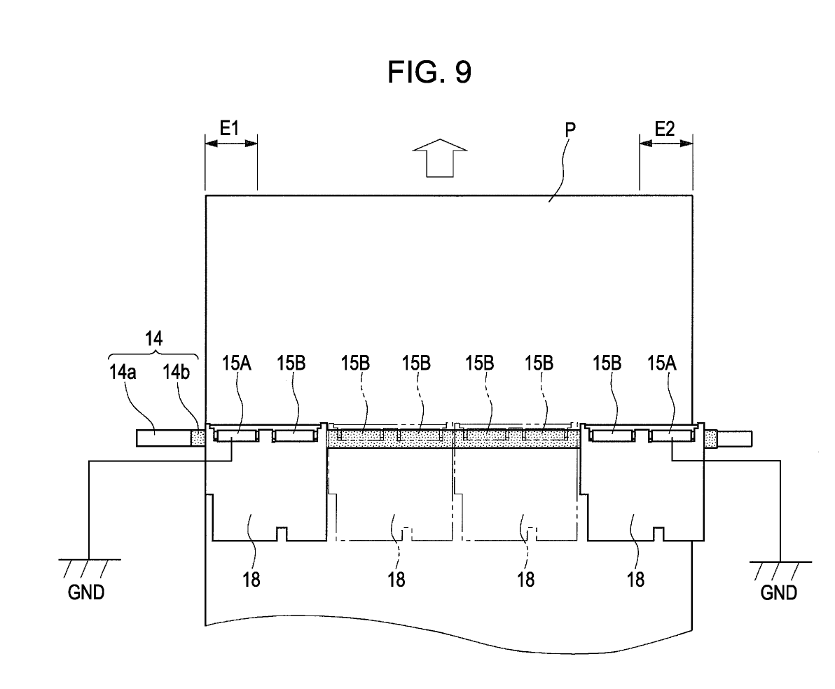

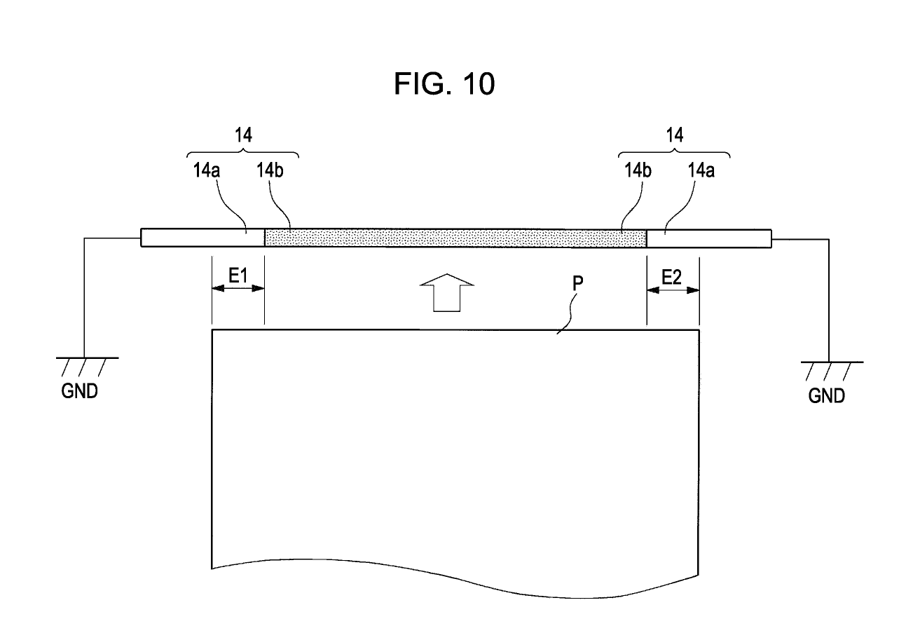

FIGS. 9 and 10 are views illustrating a member for grounding a paper end region to show a different embodiment. On the other hand, FIGS. 3 to 8 show one side end region of paper P, in which the same configuration is installed at the other side end region. In addition, a direction of the front and back surfaces of the paper in FIG. 1 is referred to as a second direction (paper widthwise direction) which is perpendicular to the paper transportation direction, that is, a first direction. In FIGS. 2 to 8, a direction of the left and right sides of the figures is referred to as the second direction (paper widthwise direction), while a direction of the front and back surfaces of the paper is referred to as the first direction (paper transportation direction). Furthermore, in FIGS. 9 and 10, an upper and lower direction of the figures is referred to as the first direction (paper transportation direction), while a left and right direction of the figures is referred to as the second direction (paper widthwise direction).

The overall configuration of an ink jet printer 1 which is a configuration common to the respective embodiments will be described in broad terms with reference to FIG. 1. The ink jet printer 1 includes a paper feeding device 2 at a bottom portion of the apparatus, and is configured to feed a recording paper P, which is one example of a medium to be ejected, from the paper feeding device 2, bend and reverse the recording paper at an intermediate roller 10, and feed the recording paper to an ink jet recording head 16 side which serves as a liquid ejecting unit to perform recording.

More specifically, the paper feeding device 2 includes a paper cassette 3, a pickup roller 7, an intermediate roller 10, a retard roller 11, and guide rollers 12 and 13. The paper feeding device 2 is provided with a separating sloped surface 5 at a position opposite to a leading end portion of the recording paper P which is contained in the paper cassette 3 detachably mounted to the paper feeding device 2. The leading end portion of the recording paper P sent by the pickup roller 7 is slid on the separating sloped surface 5 and then is fed to a downward side, so that the uppermost recording paper P to be fed is preliminarily separated from a subsequent recording paper P which is about to be doubly fed.

The pickup roller 7 constituting the paper feeding unit is pivotally supported by an oscillating member 6 which is able to be rotated around an oscillating shaft 6a in a clockwise direction and in a counterclockwise direction in FIG. 1. In addition, the pickup roller 7 is provided to be rotated by a driving force of a driving motor (not illustrated). The pickup roller 7 is rotated while coming into contact with the uppermost one of the recording papers P contained in the paper cassette 3 at the time of feeding the paper, so that the uppermost recording paper P is discharged from the paper cassette 3.

Next, the recording paper P sent from the paper cassette 3 enters a bending and reversing section. The bending and reversing section is provided with rollers of the intermediate roller 10, the retard roller 11 and the guide rollers 12 and 13.

The intermediate roller 10 is a large-diameter roller forming an inside of the bending and reversing path in which the recording paper P is bent and reversed. The intermediate roller 10 is rotated by the driving motor (not illustrated). If the intermediate roller 10 is rotated in the counterclockwise direction in FIG. 1, the recording paper P is wound around the intermediate roller and then is transported to the downward side.

The retard roller 11 is provided such that the retard roller is able to be pressingly contacted with the intermediate roller 10 in a state in which predetermined rotational friction resistance is applied to the contact, and to be spaced apart from the intermediate roller 10. Since the recording paper P is nipped between the intermediate roller 10 and the retard roller 11, the uppermost recording paper P to be fed is separated from the subsequent recording paper P which is about to be doubly fed.

In this instance, the paper feeding path adjacent to this position is provided with a paper return lever (not illustrated), so that the subsequent recording paper P, of which progress is configured to be stopped by the retard roller 11, is returned to the paper cassette 3 by the paper return lever.

The guide rollers 12 and 13 are freely rotatable rollers. Among them, the guide roller 13 assists feeding of the paper which is performed by the intermediate roller 10, since the paper P is nipped between the intermediate roller 10 and the guide roller 13.

The above description relates to the configuration of the paper feeding device 2, and the ink jet printer having the paper feeding device 2 further includes a transport driving roller 14 and a transport driven roller 15 at the downstream side of the intermediate roller 10. The transport driving roller 14 is rotated by a driving motor (not illustrated), and the transport driven roller 15 is subsequently driven in accordance with the transport of the recording paper P, with the recording paper P being nipped between the transport driving roller 14 and the transport driven roller 15.

The downstream side region of the transport driving roller 15 is a recording region in which the recording paper P is recorded. In the downstream side region, an inkjet recording head 16 serving as a liquid ejecting unit and a support member 17 serving as an ejected medium supporting unit are disposed in a mutual opposite relation, and the support member supports the recording paper P to define a distance between the recording paper P and the ink jet recording head 16.

The recording paper P is recorded between the ink jet recording head 16 and the support member 17 (the recording region), and then is discharged outwardly from the apparatus by a discharging unit which is not illustrated in FIG. 1.

### PRINCIPAL IDEA OF THE INVENTION

The above description relates to the schematic configuration of the ink jet printer 1, and the principal thought of the invention will now be described with reference to FIG. 2. In this instance, in FIG. 2, reference numeral 16a designates a metallic nozzle plate which forms a first side opposite to the support member 17 in the ink jet recording head 16 and is formed with a plurality of ink ejecting nozzles (not illustrated). Reference numeral 17a designates a rib which is formed at the support member 17 and extends in the paper transportation direction (the first direction; a front and rear direction of a figure surface in FIG. 2). A plurality of ribs 17a are formed at an appropriate interval in the paper widthwise direction (the second direction; a left and right direction of FIG. 2), and the recording paper P is supported by the ribs 17a.

In addition, reference numeral Pe designates a region of a distance w from an end portion (an end portion in the paper widthwise direction) of the paper towards the inside, that is, the paper end region, and reference numeral d designates paper powder or the like to be easily adhered to the paper end region Pe. Furthermore, reference numerals s and s′ indicate ink droplets which are ejected from the ink jet recording head 16 toward the recording paper P, in which the ink droplets s indicate ink droplets ejected in a central region except for the paper end region Pe, while the ink droplet s′ indicates an ink droplet ejected in the vicinity of the paper end region Pe.

Also, reference numeral V1 indicates a potential difference between the nozzle plate 16a and the support member 17 (a surface opposite to the nozzle plate 16a), reference numeral V2 indicates a potential difference between the nozzle plate 16a and the recording paper P, and reference numeral V3 indicates a potential difference between the support member 17 (a surface opposite to the recording paper P) and the recording paper P.

In the invention, at least the potential difference V1 in the vicinity of the paper end region Pe becomes zero, so that a field-free state is caused between the nozzle plate 16a and the support member 17. Consequently, coulomb force generated by the electric field between the nozzle plate 16a and the support member 17 does not act on the paper powder d or the like, thereby suppressing the substance d such as the paper powder or the like from flying toward the nozzle plate 16a.

In addition, in another embodiment of the invention, the potential difference V2 in the paper end region becomes zero, so that a field-free state is caused between the nozzle plate 16a and the recording paper P. Consequently, coulomb force generated by the electric field between the nozzle plate 16a and the recording paper P does not act on the paper powder d or the like, thereby further suppressing the paper powder d or the like from flying toward the nozzle plate 16a.

In this instance, if the potential difference V1 is set to be zero and the potential difference V2 is set to be zero, the potential difference V3 in the paper end region becomes zero, thereby preventing the paper powder d or the like from flying toward the support member 17 side.

The above description relates to the principal idea of the invention.

### First Embodiment

The charging state (the first embodiment) in the recording region will now be described with reference to FIG. 3. In this instance, in this embodiment and the second to fourth embodiments which will be described below, the ink jet recording head 16 is a so-called line head which is formed to have a length capable of covering the paper width and is fixedly installed. The recording is performed not by reciprocating the ink jet recording head 16 in the paper widthwise direction (the second direction), but by moving the recording paper P in the paper transportation direction (the first direction) only.

In FIG. 3, reference numerals 20A and 20B indicate a same-potential setting unit. The same-potential setting unit 20A makes the same potential at the first side opposite to the support member 17, that is, the nozzle plate 16a, in the ink jet recording head 16 and the second side opposite to the nozzle plate 16a in the support member 17, in the vicinity of the paper end region Pe of the recording paper P.

More specifically, an electrode plate (e.g., a SUS plate of about 20 mm in width) 21 is provided at a position (a position of the support member 17 when a straight line is drawn from the paper end portion to the support member 17) Qe corresponding to the paper end portion of the recording paper P in the support member 17. The electrode plate 21 is ground-connected via the nozzle plate 16a. Consequently, the potential difference between the nozzle plate 16a and the support member 17 becomes zero to cause the field-free state. In this instance, a predetermined portion of the support member 17 side which is set to the same potential with the ink jet recording head 16 side, that is, the electrode plate 21, contains the position Qe corresponding to the paper end portion in the paper widthwise direction (the second direction), and the width and the arrangement are established so as to extend to the outside of the paper (the left side in FIG. 3) and the inside of the paper (the right side in FIG. 3) more than the position Qe.

On the other hand, the recording paper P is also ground-connected via the same-potential setting unit 20B. For this reason, the potential difference between the recording paper P in the vicinity of the paper end region Pe, the nozzle plate 16a, and the support member 17 becomes zero to form the field-free state. In this instance, the same-potential setting unit 20B may be constructed by forming a roller, which is positioned further at the upstream side than the recording region including the transport driving roller 14, with a conductive material and ground-connecting the roller, or by, for example, a conductive brush.

In this instance, a point R1 indicates a terminal end position of the electrode plate 21 which is located at the position (the right side in FIG. 3) further inside than the position Qe corresponding to the paper end. A point R2 indicates a terminal end position of the nozzle plate 16a which is located at the position (the left side in FIG. 3) further outside than the position Qe corresponding to the paper end. In addition, a line indicated by a symbol E1 indicates a line connecting the point R1 and the point R2. As shown in the figure, the width and the arrangement of the electrode plate 21 and the nozzle plate 16a are set such that the line E1 is located at the position (the right side in FIG. 3) further inside than the paper end region Pe in this embodiment, that is, the line E1 intersects with the paper.

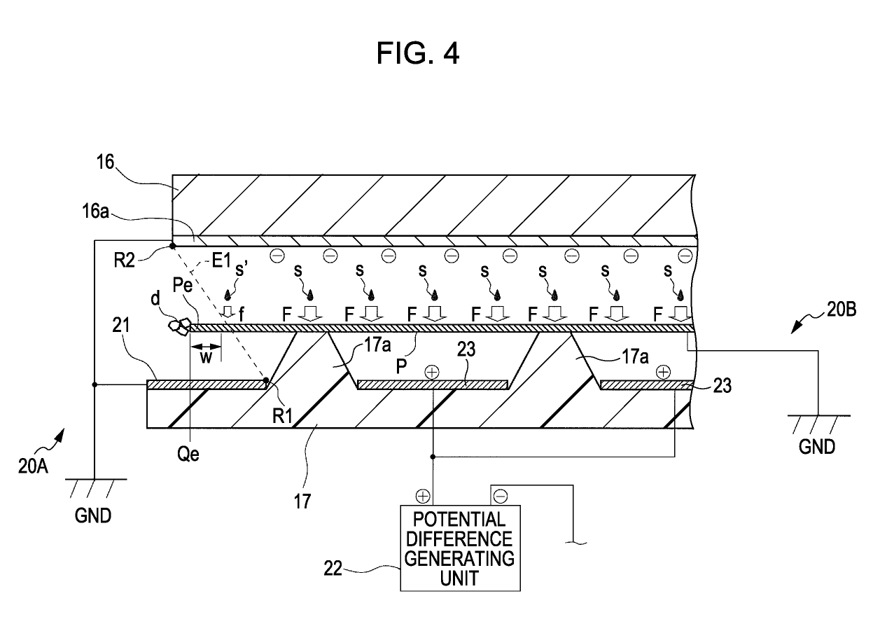

The central region (the region further right than the terminal end position R1 in FIG. 3), except for the paper end region Pe, in the widthwise direction of the recording paper P is set to generate the potential difference, that is, the electric field, between the nozzle plate 16a and the support member 17, but enters a state (non-control) in which the potential difference (intensity of the electric field) is not controlled. In this instance, the electric field is generated between the nozzle plate 16a and the support member 17 in the central region except for the paper end region Pe, but lines of electric force are not illustrated in order to avoid complication in the figures (same in FIGS. 4 to 8).

That is, since a dedicated potential difference generating unit is provided, the potential difference (the intensity of the electric field) between the nozzle plate 16a and the support member 17 is not controlled (non-control). However, since the support member 17 is made of a resin material and has a dielectric property, the support member is electrically charged by friction between the recording paper P and the support member. As a result, there is the state in which the potential difference (the electric field) is able to be generated between the nozzle plate 16a and the support member 17.

Symbols “+” and “−” which are encircled in FIG. 3 indicate charged polarity (same in FIGS. 4 to 8), and the example of FIG. 3 shows the state in which the support member 17 is electrically charged with negative polarity by the frictional electrification. Accordingly, since the support member 17 is electrically charged with the negative polarity in the central region except for the paper end region Pe, positive charges exist on the support member 17 side of the nozzle plate 16a by electrostatic induction, so that the ink droplets s are electrically charged with the same positive polarity as the nozzle plate 16a.

The ejected ink droplets s are attracted to the recording paper P side between the nozzle plate 16a and the recording paper P by coulomb force F (=qE; q indicates charges of the ink droplets s and E indicates the electric field), so that the ink droplets are reliably landed on the recording paper P. In this instance, if the support member 17 is electrically charged with the positive, the ink droplets s are electrically charged with the negative by the electrostatic induction, and thus the ink droplets are also attracted to the recording paper P.

Next, since the end region of the recording paper P is set as the field-free state as described above, the coulomb force does not act on the paper powder d or the like. For this reason, the paper powder d or the like is discharged outward from the apparatus without scattering or flying, while being adhered to the paper end region Pe. In this instance, the coulomb force generated by the electric field does not act on the discharged ink droplets s′ in the end region of the recording paper P, so that the ink droplets are not attracted to the recording paper P by the coulomb force. However, since the ink droplets are not applied with the coulomb force in a direction for interrupting the landing onto the recording paper P, the ink droplets are landed on the recording paper P by kinetic energy f generated by the discharge.

According to this embodiment as described above, the potential (the ground potential) of the ink jet recording head 16, the support member 17, and the recording paper P is equal to each other with respect to the paper end region Pe of the recording paper P, and thus there is the field-free state in the paper end region Pe. The paper end region Pe, to which the paper powder d or the like is most prominently adhered, is laid in the field-free region. Therefore, it is possible to suppress the paper powder d or the like adhered to the paper end region Pe from scattering or flying, and most of the paper powder d or the like is discharged outwardly from the apparatus together with the recording paper P, with the paper powder d or the like being adhered to the paper end region Pe as it is. Consequently, it is possible to reliably prevent the paper powder d or the like from being adhered to the nozzle plate 16a.

Since the portion (the right side in FIG. 3) of the support member 17, which is located at a position further inside than the electrode plate 21, is made of the resin material, the electric field may be generated between the support member 17 and the nozzle plate 16a in the region (the right side in FIG. 3) which is located at a position further inside than the line E1. That is, even though the paper end region Pe is interposed between the electrode plate 21 and the nozzle plate 16a, the electric field is generated as described above. If the paper end region Pe enters such an electric field, the paper powder d or the like adhered to the paper end region Pe may be scattered or fly towards the nozzle plate 16a.

As described above, however, since the line E1 is located at further at the inside (the right side in FIG. 3) of the paper than the paper end region Pe, that is, the line E1 intersects with the paper, the paper end region Pe is reliably in the field-free state. Therefore, it is possible to reliably prevent the paper powder d or the like adhered to the paper end region Pe from scattering or flying towards the nozzle plate 16a.

This embodiment is configured such that a region w which is further inside than the paper is set to be the paper end region Pe, and the line E1 passes through the portion further inside than the region. However, if at least the portion further inside than the paper end (an edge) is configured such that the line E1 passes, it is possible to prevent the paper powder d or the like from scattering to some extent. In addition, the paper end region w may be set to be, for example, about 2 mm in which adhesion of the paper powder d or the like is most prominent, in consideration of the adhering amount of the paper powder d or the like, or may be set as a range (e.g., w≈2 to 5 mm) with some margins relative to the above level. That is, the paper end region w may be appropriately adjusted in accordance with the adhering amount of the paper powder d or the like.

In addition, since this embodiment is configured such that the potential difference is generated between the nozzle plate 16a and the support member 17 in the central region, except for the paper end region Pe, the electric field is formed in the central region. Therefore, the ink droplets s discharged from the ink jet recording head 16 are reliably landed onto the recording paper P, thereby solving the problem of mist floating. In this instance, if the landing of the ink droplets s is not taken into consideration, it is not necessary to form the potential difference (the electric field) in the central region except for the paper end region Pe.

### Second Embodiment

The second embodiment of the invention will now be described with reference to FIG. 4. In this instance, the same constituent elements are indicated by the same reference numerals, and the description thereof will be omitted herein (also in other embodiments described below).

This embodiment is substantially identical to the first embodiment which has been described with reference to FIG. 3, except that the potential difference (intensity of the electric field) generated between the nozzle plate 16a and the support member 17 by a potential difference generating unit 22 in the central region except for the paper end region Pe is controlled.

That is, the paper support member 17 is provided with an electrode plate 23 between the ribs 17a and 17a in the central region except for the paper end region Pe. The electrode plate 23 is connected to a positive polarity (e.g., +500V) of the potential difference generating unit 22, so that the potential difference, that is, the electric field, is generated between the paper support member 17 and the nozzle plate 16a.

Accordingly, the ink droplets s discharged from the ink jet recording head 16 are electrically charged with the negative polarity since the nozzle plate 16a is electrically charged with negative polarity by the electrostatic induction. Then, the ink droplets are attracted to the support member 17 side by the coulomb force, and thus are reliably landed on the recording paper P.

In this way, since the potential difference (the intensity of the electric field) in the central region except for the paper end region Pe is controlled, it is possible to more reliably prevent the ink droplets s from misting in the central region. In this instance, although the electrode plate 23 is connected to the positive polarity of the potential difference generating unit 22 in this embodiment, the electrode plate 23 may be connected to the negative polarity.

### Third Embodiment

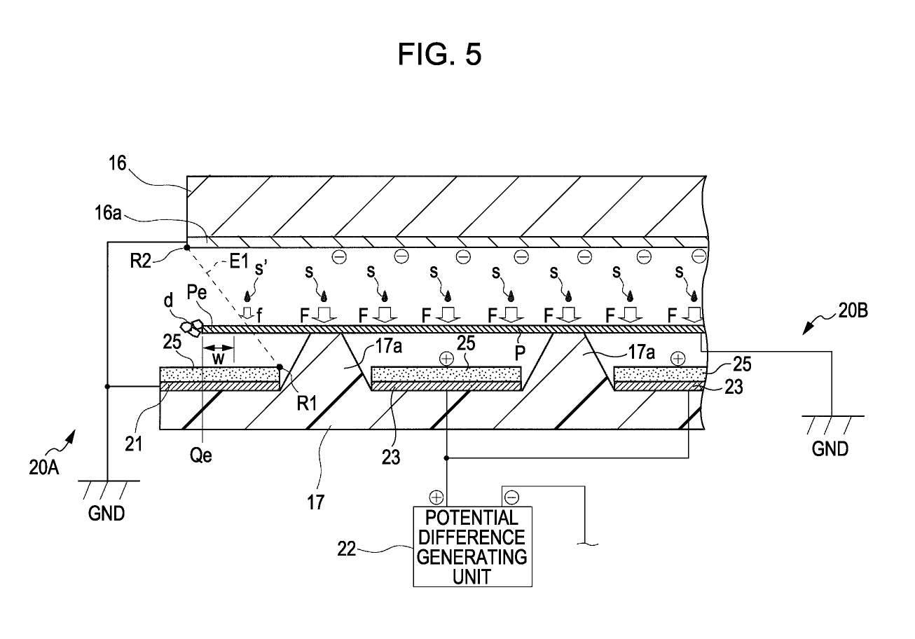

The third embodiment of the invention will now be described with reference to FIG. 5. This embodiment is substantially identical to the second embodiment which has been described with reference to FIG. 4, except that an ink absorbing material 25 is provided on the upper portion of the electrode plates 21 and 23. As the ink droplets are discharged toward the region deviating from the recording paper P (e.g., during flushing in which the ink is discharged in an idling mode or at the time of borderless printing), the ink droplets are able to be reliably caught by the ink absorbing material 25, thereby solving the problem of mist floating.

In this instance, the upper surface of the ink absorbing material 25 is located at a position lower than a top portion of the rib 17a, and thus it prevents to the rear surface of the recording paper P from being damaged by the ink absorbing material 25. For example, the interval of the distance from the bottom surface of the nozzle plate 16a to the ink absorbing material 25 is provided at about 2 to 4 mm, and the interval of the distance from the bottom surface of the nozzle plate 16a to the upper surface of the recording paper P is provided at about 1 mm (the thickness of the recording paper P is 1 mm or less).

The ink absorbing material 25 is formed to have a property as a conductor in this embodiment, for example, a conductive property of 102 to 108Ω/□ (e.g., about 105Ω/□) in surface resistivity. More specifically, as the ink absorbing material, one in which a resin such as polyethylene or polyurethane is mixed with a conductive material such as metal or carbon and then is foamed, or one in which the resin foamed material such as polyethylene or polyurethane is adhered or plated with a conductive material such as metal or carbon may be used. Alternatively, one in which the resin foamed material such as polyethylene or polyurethane is impregnated with an electrolyte solution may be used.

Since the ink absorbing material 25 has the conductive property, the potential of the uppermost surface of the ink absorbing material 25 (the uppermost surface of the nozzle plate side) is able to be reliably controlled. Accordingly, the field-free state is able to be reliably formed in the paper end region Pe. In addition, it is possible to prevent the ink droplets s from being misted by accurately controlling the electric field in the central region except for the paper end region Pe.

In this instance, since the potential of the uppermost surface of the ink absorbing material 25 is equal to the potential of the nozzle plate 16a in this embodiment, the origin R1 of the line E1 becomes a terminal end position of the uppermost surface of the ink absorbing material 25 at the inside of the paper.

### Fourth Embodiment

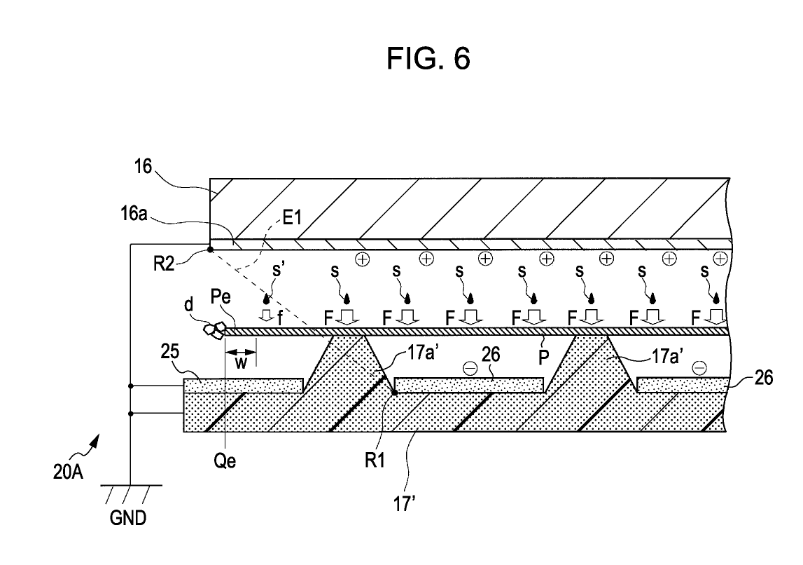

The fourth embodiment of the invention will now be described with reference to FIG. 6. This embodiment is substantially identical to the third embodiment which has been described with reference to FIG. 5, except that since a support member (designated by reference numeral 17′) has a conductive property (e.g., surface resistivity is about 102 to 108Ω/□), the electrode plates 21 and 23 and the same-potential setting unit 20B ground-connecting the recording paper P are omitted, and an ink absorbing material 26 having an insulation property is provided in the central region except for the paper end region Pe.

That is, since the support member 17′ itself is a conductor and is ground-connected, the electrode plate 21 is not necessary, so that the apparatus is able to have a simple configuration and be manufactured with the low cost. As the support member 17′, for example, one in which a resin is mixed with a conductive material such as metal or carbon may be used. In this instance, after the support member is made of the insulation material, a conductive material such as metal or carbon may be adhered to the surface thereof.

In the fourth embodiment, since the rib 17a′ of the support member 17′ comes into contact with the recording paper P, the potential of the nozzle plate 16a, the recording paper P and the support member 17′ can be equal to each other (the field-free state) in the paper end region, without providing a separate unit for controlling the potential of the recording paper P.

In addition, in the central region except for the paper end region Pe, since the ink absorbing material 26 having the insulation property is provided, the electric field is generated by the electrical charging of the ink absorbing material 26 (whereas the potential difference is not controlled), so that the ink droplets s discharged from the inkjet recording head 16 are attracted to the ink absorbing material 26 side by the coulomb force, that is, the ink droplets s are reliably landed onto the recording paper P, thereby solving the problem of mist floating.

In this instance, since the support member 17′ itself is made of the conductor in this embodiment, the terminal end position R1 at the inside of the paper which is the origin of the line E1 becomes the terminal end position of the ink absorbing material 26, which is the insulator, at the outside of the paper.

### Fifth Embodiment

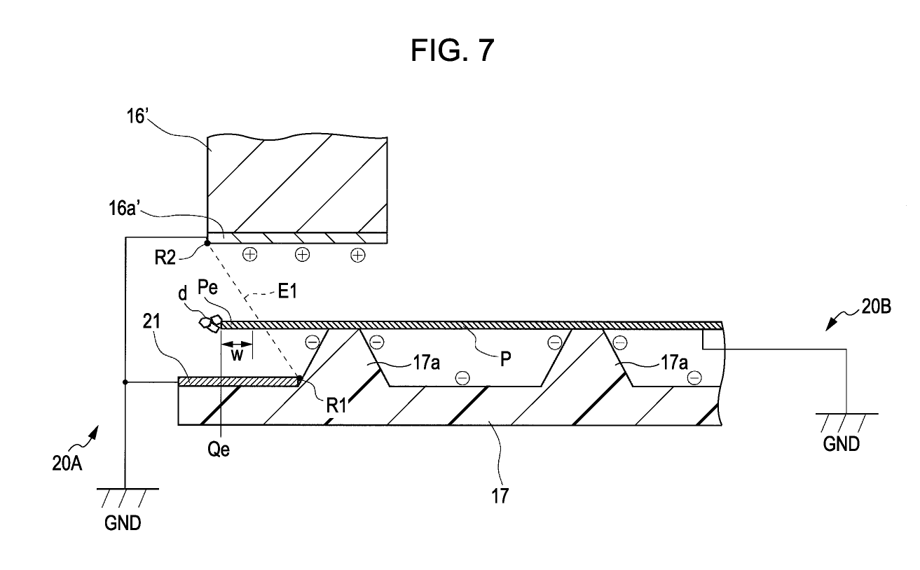

The fifth embodiment of the invention will now be described with reference to FIG. 7. This embodiment is substantially identical to the first embodiment which has been described with reference to FIG. 3, except that an ink jet recording head (designated by reference numeral 16′) is a serial type which is moved in the widthwise direction of the paper (in the left and right direction in FIG. 7) to discharge the ink droplets.

Similar to the first embodiment, the potential of the ink jet recording head 16′, the support member 17, and the recording paper P is equal to each other with respect to the paper end region Pe in such a serial-type ink jet printer, and thus the field-free state occurs in the paper end region Pe. As a result, the paper end region Pe, to which the paper powder d or the like is most prominently adhered, is laid in the field-free region. Therefore, it is possible to suppress the paper powder d or the like adhered to the nozzle plate 16a from scattering or flying, and most of the paper powder d or the like is discharged outwardly from the apparatus together with the recording paper P, with the paper powder d or the like being adhered to the paper end region Pe as it is. Consequently, it is possible to reliably prevent the paper powder d or the like from being adhered to the nozzle plate 16a′.

In addition, since the potential difference is generated between the nozzle plate 16a′ and the support member 17 in the central region except for the paper end region Pe, the electric field is generated in the central region. The ink droplets s discharged from the ink jet recording head 16 are reliably landed onto the recording paper P, thereby solving the problem of the mist floating.

In this instance, the position of the ink jet recording head 16′ shown in FIG. 7 is a position opposite to the paper end region Pe. In a recording process of alternatively and repeatedly performing an operation (main scanning) of executing the recording by moving the inkjet recording head 16′ and an operation (sub-scanning) of transporting the paper in the predetermined amount, the position is one example of a position in which when main scanning is completed one time and the paper transporting operation is performed, the ink jet recording head 16′ is stopped.

When the ink jet recording head 16′ is stopped at the position, if the paper is transported, the paper powder d or the like adhered to the paper end region Pe may be scattered and fly toward the nozzle plate 16a′ by the vibration generated at the time of transport, and thus may be adhered thereto. However, since this embodiment is configured such that the line E1 intersects with the paper, the paper end region Pe is reliably laid in the field-free state, thereby reliably preventing the paper powder d or the like adhered to the paper end region Pe from scattering or flying toward the nozzle plate 16a.

### Sixth Embodiment

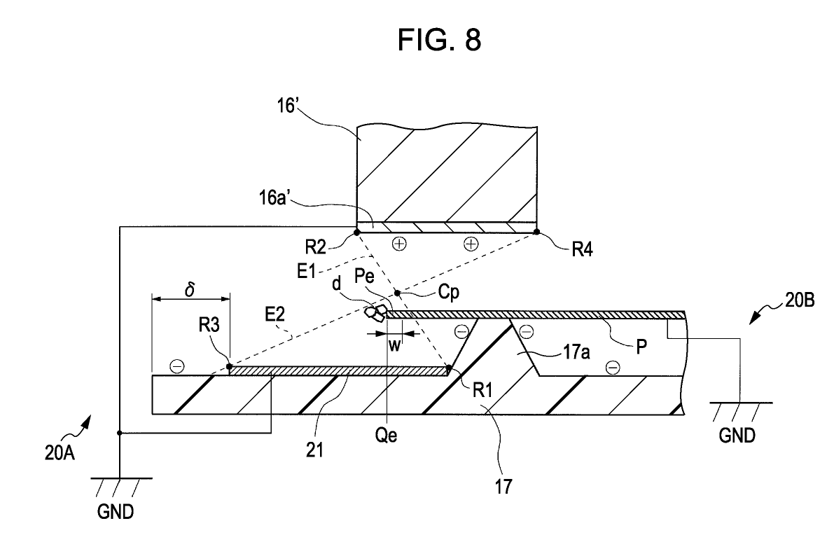

The sixth embodiment of the invention will now be described with reference to FIG. 8. This embodiment is substantially identical to the fifth embodiment which has been described with reference to FIG. 7, except that there is a region δ of the support member 17, which is not covered by the electrode plate 21, at a position further outside than the electrode plate 21 (left side in FIG. 8). If such a region δ exists, the potential difference (the electric field) may be generated between the region 6 and the nozzle plate 16a.

Herein, in FIG. 8, a point R3 indicates a terminal end position of the electrode plate 21 which is located at the position (the left side in FIG. 8) further outside than the paper end, and a point R4 indicates a terminal end position of the nozzle plate 16a which is located at the position (the right side in FIG. 8) far from the terminal end position R3. In addition, a line designated by a symbol E2 indicates a line connecting the point R3 and the point R4. The electric field may be generated in the region which is located at the position (the left side in FIG. 8) further outside than the line E2 by the region 6, but this embodiment is configured such that the line E2 is located at the position (the left side in FIG. 8) further outside than the paper end region Pe, as shown in the figure, that is, the line E2 does not intersect with the paper.

Therefore, the paper end region Pe is located at the outside of the electric field which is generated between the region δ of the support member 17 and the nozzle plate 16a′, that is, the paper end region Pe is reliably laid in the field-free state, so that it is possible to reliably prevent the paper powder d or the like adhered to the paper end region Pe from scattering or flying toward the nozzle plate 16a.

In this instance, a symbol Cp in FIG. 8 indicates an intersection point of the line E1 and the line E2. This embodiment is configured such that the paper end region Pe is within a triangular region enclosed by the line E1 and the line E2 which is lower than the intersection point Cp, but may be configured such that the paper end region Pe is within an inverted-triangular region enclosed by the line E1 and the line E2 which is higher than the intersection point Cp.

### Other Variations

### 1. Same-Potential Setting Unit of Paper End Region

In each of the above-described embodiments, in order to form the field-free state by making the potential of the nozzle plate 16a (16a′), the recording paper P, and the support member 17 (17′) be equal to each other in the paper end region, these constituent elements are ground-connected. However, if the potentials are identical to each other, the field-free state can be formed. Therefore, it is not limited to the ground connection, and it is no matter that arbitrary voltage of arbitrary polarity is applied thereto.

In each of the above-described embodiments, the potentials of the nozzle plate 16a (16a′), the recording paper P, and the support member 17 (17′) are equal to each other in the paper end region, but the effect of preventing the paper powder or the like from being adhered (the attachment preventing effect of the paper powder or the like to the nozzle plate) can be obtained even by making the potentials only between the nozzle plate 16a (16a′) and the support member 17 (17′) be equal to each other and using the configuration in which the potential is not controlled (floating) with respect to the recording paper P.

In addition, in each of the above-described embodiments, the region corresponding to the end portion of the recording paper of a certain size (e.g., A4 size) is in the field-free state. In order to correspond to recording papers of plural sizes, however, a plurality of field-free regions may be arranged (in the paper widthwise direction) according to the size.

In the case of small-size paper, since the further outside part of the region which is set in the field-free state becomes the electric field generating region, it is possible to prevent the ink mist from scattering in the outside region of the recording paper P.

In each of the above-described embodiments, this instance, the configuration of the invention is applied to both one lateral end potion and the other lateral end portion of the paper P, but the invention is not limited to the above configuration. Even in a case where the configuration of the invention is applied to one lateral end region of the paper P only, it is needless to say that the working effect is obtained.

### 2. Potential Difference of Central Region Except for Paper End Region

In each of the above-described embodiments, the potential difference (the electric field) is mainly provided in the central region, except for the paper end region Pe, as measures for the mist floating. However, in the case where the potential difference (the electric field) is not provided, at least the effect of preventing the paper powder d or the like from scattering and flying can be obtained in the above-described paper end region.

### 3. Nozzle Plate

In each of the above-described embodiments, a water repellent film may be provided on the surface of the nozzle plate 16a (16a′). Herein, if the water repellent film of having a conductive property is used, it is possible to suppress the charging of the water repellent film, thereby suppressing the paper powder or the like from being adhered to the nozzle plate 16a (16a′) and reliably controlling the potential of the nozzle plate side.

In addition, if the water repellent film having an insulation property is used, it is possible to lessen an image force (if paper powder with a charge or the like approaches the nozzle plate, a charge opposite to the charge of the paper powder or the like appears on the nozzle plate side, and thus mutual attraction occurs) of the nozzle plate 16a (16a′) made of metal such as SUS or the like, thereby preventing the paper powder or the like flying in the vicinity of the nozzle plate from being attracted to the nozzle plate 16a (16a′).

In this instance, it is preferable that the predetermined portion applying (controlling) the potential is the furthest toward the support member 17 side, that is, the nozzle plate 16a, in the inkjet recording head 16. More specifically, it is preferable that the predetermined portion is a nozzle surface which is a surface opposite to the support member 17. Consequently, since the potential of the nozzle surface closest to the recording paper P is controlled, it is possible to suppress the electric field from flowing in from its surroundings and also to effectively prevent the attachment of the paper powder or the like to the nozzle surface. At that time, it is preferable that since it is identical to the support member 17 side, the predetermined portion controlling the potential is a surface opposite to the nozzle plate 16a.

### 4. Electrode Plate

In each of the above-described embodiments (in particular, each of the first, second, and fifth embodiments), the electrode plates 21 and 23 provided at the support member 17 may substitute the conductive ink absorbing member 25 shown in FIGS. 5 and 6.

In addition, the electrode plates 21 and 23 may be configured to come into contact with the recording paper P, but it is preferable that the electrode plates are arranged by securing the predetermined interval between the electrode plates and the recording paper P so as not to come into contact with the recording paper P. Accordingly, it is possible to suppress the paper powder from being accumulated on the electrode plates 21 and 23, and in particular, to suppress the charged paper powder or the like from being adhered thereto due to the image force, as well as the physical attachment thereof.

### 5. Grounding Unit of Recording Paper

In each of the above-described embodiments, in the case where the potential difference between the nozzle plate 16a (16a′) and the recording paper P is not zero, if the potential difference between the nozzle plate 16a (16a′) and the support member 17 (17′) is set to be zero, it is possible to obtain the desired effect of preventing scattering of the paper powder.

In addition, in each of the above-described embodiments (in particular, each of the first to the third, and fifth embodiments), the ground connection of the recording paper P can be performed by various measures, and, for example, the recording paper P may be brought into contact with a conductive brush which is grounded to an arbitrary place.

Furthermore, the recording paper may be ground-connected via each of the rollers arranged on the paper transporting path. FIG. 9 shows one example of the ground connection, in which the recording paper is ground-connected via the transport driven roller designated by reference numeral 15A. The transport driven roller designated by reference numeral 15A is a transport driven roller which is provided at the endmost portion in the paper widthwise direction, and is formed of a conductive material and also is ground-connected. Accordingly, the end region (designated by the symbols E1 and E2) is of the recording paper P ground-connected, so that it concentrately becomes the ground potential.

In this instance, reference numeral 18 designates an upper guide member which supports the transport driven rollers 15A and 15B in a free rotatable manner. The transport driven roller designated by the reference numeral 15B is a roller made of an insulation material. However, in place thereof, the transport driven roller 15A which is made of a conductive material and is also ground-connected may be employed over the paper widthwise direction.

The transport driving roller 14 which is pressingly contacted with the transport driven rollers 15A and 15B is adhered with abrasion-resistant particles so as to increase a frictional force between the recording paper P and the surface of a metallic shaft body, in which reference numeral 14a designates a metal surface which is not adhered with the abrasion-resistant particles, and reference numeral 14b designates a high-frictional surface (having a dielectric property in this embodiment) which is adhered with the abrasion-resistant particles.

Accordingly, as shown in FIG. 10, since the metal surface 14a is extended in the inside of the paper transport region and the paper end regions E1 and E2 are formed by the metal surface 14a and are also ground-connected, the end regions E1 and E2 of the recording paper P can be ground-connected, so that the paper end regions concentrately become the ground potential.

### 6. Impartment of Charge to Ink Droplets

In each of the above-described embodiments, the ink droplets are electrically charged by the induced charge which passes through the nozzle plate 16a (16a′), but the charge may be imparted to the ink droplets at an arbitrary position in the ink flow passage which extends from an ink storage chamber (e.g., ink cartridge or the like) storing the ink therein to the nozzle plate 16a (16a′). For example, a portion or the whole of the inner wall of the ink storage chamber may be made of a conductive member, and then the ink may be imparted with the charge via the inner wall.

In this instance, for example, the polarity imparted to the ink is preferably given with the negative polarity, since the support member 17 side in the central region except for the paper end region is connected to the positive polarity of the potential difference generating unit 22 according to the second embodiment shown in FIG. 4 or the third embodiment shown in FIG. 5. In addition, in the case where the potential of the support member 17 side in the central region except for the paper end region is not controlled, that is, in the case where the charging is performed by the frictional charge or contact charge, the polarity to be imparted to the ink is determined on the basis of whether the material forming the support member 17 is easily charged with one of positive polarity and negative polarity in a series of electrification.

In this instance, the electric field between the ink jet recording head 16 and the support member 17 (or the recording paper) in the paper end region can be extremely lessened by applying the same potential as the support member 17 side (or the recording paper) to the ink as the liquid, thereby configuring measures to prevent paper powder from being adhered to the nozzle plate 16a. That is, for example, the nozzle plate 16a is not limited to a conductor such as metal, and it may be made of dielectric such as silicon, acryl, or polyimide. In this instance, if the potential of the ink in the head is not controlled, the electric field generated by the potential difference between the ink in the head and the support member 17 has a strong influence onto the paper powder, whereby the paper powder may fly toward the nozzle plate 16a side. However, such a problem can be solved by applying the same potential as the support member 17 side to the ink in the head.

In addition, in the case where the nozzle plate 16a is made of the dielectric, it is possible that the only the ink flow passage portion (a portion to be contacted with the ink) in the nozzle plate is made of a conductive material, as the configuration of applying the potential to the ink in the head, and thus the potential is imparted to the ink via the conductive member. For example, in a case where the nozzle plate has a stacked structure, all of the layers can be made of a conductive member, or the ink flow passage of at least one of the layers can be made of the conductive member.

What is claimed is:

1. A liquid ejecting apparatus comprising:
a liquid ejecting unit which is fixed in a second direction perpendicular to a first direction which is a transportation direction of a medium to be ejected, and ejects a liquid onto the medium to be ejected;
a medium-to-be-ejected supporting unit which is provided opposite to the liquid ejecting unit and supports the medium to be ejected; and
a same-potential setting unit which sets the same potential to a predetermined portion of the liquid ejecting unit side and a predetermined portion of the medium-to-be-ejected supporting unit side;
in which a region of the predetermined portion of the medium-to-be-ejected supporting unit side in the second direction has a position corresponding to at least one lateral end of the medium to be ejected in the second direction, and extends towards inside and outside of the medium to be ejected from the position; and
at least the one lateral end of the medium to be ejected in the second direction is configured so that a line connecting a terminal end position of the predetermined portion of the medium-to-be-ejected supporting unit side which is further inside than an end portion of the medium to be ejected, and a terminal end position of the predetermined portion of the liquid ejecting unit which is further outside than the end portion of the medium to be ejected, intersects with the medium to be ejected.

2. A liquid ejecting apparatus comprising:
a liquid ejecting unit which ejects a liquid onto the medium to be ejected while moving is moved in a second direction perpendicular to a first direction which is a transportation direction of a medium to be ejected;
a medium-to-be-ejected supporting unit which is provided opposite to the liquid ejecting unit and supports the medium to be ejected; and
a same-potential setting unit which sets to the same potential at a predetermined portion of the liquid ejecting unit side and a predetermined portion of the medium-to-be-ejected supporting unit side;
in which a region of the predetermined portion of the medium-to-be-ejected supporting unit side in the second direction has a position corresponding to at least one lateral end of the medium to be ejected in the second direction, and extends towards inside and outside of the medium to be ejected from the position; and
when the medium to be ejected is transported in a state in which the liquid ejecting unit is stationary in the vicinity of the one lateral end region of the medium to be ejected in the second direction, at least the one lateral end of the medium to be ejected in the second direction is configured so that a line connecting a terminal end position of the predetermined portion of the medium-to-be-ejected supporting unit side which is further inside than an end portion of the medium to be ejected, and a terminal end position of the predetermined portion of the liquid ejecting unit which is further outside than the end portion of the medium to be ejected, intersects with the medium to be ejected.

3. The liquid ejecting apparatus according to claim 1, wherein a line connecting a terminal end position of the predetermined portion of the medium-to-be-ejected supporting unit side which is further outside than the end portion of the medium to be ejected, and a terminal end position of the predetermined portion of liquid ejecting unit which is farther than the outer terminal end position in the predetermined portion of the medium-to-be-ejected supporting unit side does not intersect with the medium to be ejected.

4. The liquid ejecting apparatus according to claim 1, wherein the same-potential setting unit sets the same potential to the medium to be ejected, in addition to the predetermined portion of the liquid ejecting unit side and the predetermined portion of the medium-to-be-ejected supporting unit side.

5. The liquid ejecting apparatus according to claim 4, wherein the same-potential setting unit sets the same potential to the predetermined portion of the liquid ejecting unit side, the predetermined portion of the medium-to-be-ejected supporting unit side and the medium to be ejected by ground connection.

6. The liquid ejecting apparatus according to claim 1, wherein the predetermined portion of the liquid ejecting unit side is a surface opposite to the medium-to-be-ejected supporting unit, and the predetermined portion of the medium-to-be-ejected supporting unit side is a surface opposite to the liquid ejecting unit.

7. The liquid ejecting apparatus according to claim 2, wherein a line connecting a terminal end position of the predetermined portion of the medium-to-be-ejected supporting unit side which is further outside than the end portion of the medium to be ejected, and a terminal end position of the predetermined portion of liquid ejecting unit which is farther than the outer terminal end position in the predetermined portion of the medium-to-be-ejected supporting unit side does not intersect with the medium to be ejected.

8. The liquid ejecting apparatus according to claim 2, wherein the same-potential setting unit sets the same potential to the medium to be ejected, in addition to the predetermined portion of the liquid ejecting unit side and the predetermined portion of the medium-to-be-ejected supporting unit side.

9. The liquid ejecting apparatus according to claim 8, wherein the same-potential setting unit sets the same potential to the predetermined portion of the liquid ejecting unit side, the predetermined portion of the medium-to-be-ejected supporting unit side and the medium to be ejected by ground connection.

10. The liquid ejecting apparatus according to claim 2, wherein the predetermined portion of the liquid ejecting unit side is a surface opposite to the medium-to-be-ejected supporting unit, and the predetermined portion of the medium-to-be-ejected supporting unit side is a surface opposite to the liquid ejecting unit.

11. A liquid ejecting apparatus comprising:
a liquid ejecting unit which ejects a liquid onto a medium to be ejected;
a medium-to-be-ejected supporting unit which is provided opposite to the liquid ejecting unit and supports the medium to be ejected,
a same-potential setting unit which sets to the same potential at a predetermined portion of the liquid ejecting unit side and a predetermined portion of the medium-to-be-ejected supporting unit side in an end region of the medium to be ejected in a second direction perpendicular to a first direction which is a transportation direction of a medium to be ejected; and
a region in the second direction except for the end region is configured so that a difference in potential is set between the predetermined portion of the liquid ejecting unit side and the predetermined portion of the medium-to-be-ejected supporting unit side.

12. The liquid ejecting apparatus according to claim 11, wherein the same-potential setting unit sets the same potential to the predetermined portion of the liquid ejecting unit side and the medium to be ejected.

13. The liquid ejecting apparatus according to claim 11, wherein a plurality of regions, in which the same potential is set to the predetermined portion of the liquid ejecting unit side and the predetermined portion of the medium-to-be-ejected supporting unit side, are provided depending upon a size of the medium to be ejected having plural sizes in the second direction.

14. The liquid ejecting apparatus according to claim 12, wherein the same-potential setting unit sets the same potential to the predetermined portion of the liquid ejecting unit side, the predetermined portion of the medium-to-be-ejected supporting unit side and the medium to be ejected by ground connection.

15. The liquid ejecting apparatus according to claim 12, wherein the same-potential setting unit has a contact portion which comes into electrically contact with the end region of the medium to be ejected, and the contact portion is provided at an upstream side of the liquid ejecting unit in a transporting path along which the medium to be ejected is transported, and is constituted of a roller which transports the medium to be ejected.

16. The liquid ejecting apparatus according to claim 11, wherein the predetermined portion of the liquid ejecting unit side is a surface opposite to the medium-to-be-ejected supporting unit, and the predetermined portion of the medium-to-be-ejected supporting unit side is a surface opposite to the liquid ejecting unit.

17. The liquid ejecting apparatus according to claim 11, wherein a region of the predetermined portion of the medium-to-be-ejected supporting unit side in the second direction has a position corresponding to at least one lateral end of the medium to be ejected in the second direction, and extends towards the inside and outside of the medium to be ejected from the position, and
at least the one lateral end of the medium to be ejected in the second direction is configured so that a line connecting a terminal end position of the predetermined portion of the medium-to-be-ejected supporting unit which is further inside than an end portion of the medium to be ejected, and a terminal end position of the predetermined portion of the liquid ejecting unit which is further outside than the end portion of the medium to be ejected, intersects with the medium to be ejected.
